(19) United States
(12) Patent Application Publication
(10) Pub. No.: US 2015/0248633 A1
(43) Pub. Date: Sep. 3, 2015

(54) Workplace Fantasy League

(71) Applicant: Allan Grane, Elmhurst, IL (US)

(72) Inventor: Allan Grane, Elmhurst, IL (US)

(21) Appl. No.: 14/599,133

(22) Filed: Jan. 16, 2015

Related U.S. Application Data
(60) Provisional application No. 61/947,202, filed on Mar. 3, 2014.

(51) Int. Cl. G06Q 10/06; A63F 13/46

(52) U.S. Cl. CPC G06Q 10/06398; A63F 13/46

(57) ABSTRACT

An exemplary method for operating a workplace fantasy league may include assigning each of a plurality of employees to a respective one of a plurality of teams. The method may further include associating respective point values with a plurality of activities that may be undertaken by the employees, and a plurality of outcomes that may be affected by the employees. The method may further include recording instances of the activities and the outcomes, and determining point totals for each of the teams according to the recorded instances of activities and outcomes. The method may further include providing an award to employees associated with winning teams, and/or to employees based on individual point totals.

### CROSS-REFERENCE TO RELATED APPLICATION

This application claims the benefit of U.S. provisional application No. 61/947,202, filed Mar. 3, 2014, which is hereby incorporated by reference in its entirety.

### BACKGROUND

a. Technical Field

The instant application relates to workplace incentive programs, including workplace fantasy leagues, and in particular, an exemplary embodiment of the instant application relates to an incentive program that utilizes a workplace fantasy transportation or trucking league.

b. Background Art

Workplace incentive programs are generally used to encourage particular behaviors within an organization. Such programs may involve providing rewards, in addition to traditional pay and bonuses, for particular activities, particular outcomes, or for a certain amount of tenure within an organization. Incentive programs are typically on an individualized or basis, resulting in employee-versus-employee competition for tasks and outcomes that may be beneficial to the organization, but may also be detrimental. Even where incentive programs are on a team basis, individual contributions may not be adequately tracked to encourage maximum individual incentive.

### SUMMARY

Workplace incentive programs, and intra-organization incentive programs in general, may be improved by applying concepts from fantasy leagues, such as fantasy sports leagues, to a game in which a number of members of an organization, such as a number of employees, may partake.

An exemplary method for operating a game for a plurality of employees may include assigning each of the plurality of employees to a respective one of a plurality of teams, such that each of the plurality of teams comprises two or more of the plurality of employees. The method may further include associating respective point values with at least one of: (a) each of a plurality of activities that may be undertaken by one or more of the plurality of employees or one or more of the plurality of teams, and (b) each of a plurality of outcomes that may be affected by one or more of the plurality of employees or one or more of the plurality of teams. The method may further include recording instances of the activities and the outcomes over a predetermined period of time, and determining point totals for each of the teams for the predetermined period of time according to the recorded instances of activities and outcomes and the respective point values associated with the recorded activities and outcomes. The method may further include providing an award to one or more employees associated with one or more teams according to the predetermined point totals.

As described in detail below, an exemplary embodiment of such a workplace fantasy league can include the transportation and/or trucking industry, and in particular, the game can utilize employees in the transportation industry. The league is made up of teams of employees or players chosen in a draft. The players may be selected from one organization or from many, and those making the selections, likewise, may be from the same organization, or from multiple organizations.

Once the draft is complete, certain point values can be associated with certain activities undertaken by the employees in the league and with outcomes that may be affected by the employees. Each team can accumulate points according to the performance of the players on the team. Further, the players in the present workplace fantasy league may have a stake in the outcome of the fantasy league through league awards and friendly competition within the workplace. Based on this, the workplace fantasy league may be an effective tool to encourage performance of players on a team and to encourage cooperation and teamwork among players on a team.

Other objects and advantages of the instant application will become apparent to one having ordinary skill in the art after reading the specification in light of the drawing figures, however, the spirit and scope of the present disclosure should not be limited to the description of the embodiments contained herein.

### BRIEF DESCRIPTION OF THE DRAWINGS

FIG. 1 is a block diagram view of an exemplary embodiment of a system for operating a workplace fantasy league.

FIG. 2 is a flow chart illustrating an exemplary method of operating a workplace fantasy league.

FIG. 3 is an exemplary table illustrating points awarded to a fantasy team according to activities and outcomes recorded for that team.

FIG. 4 is a table illustrating an exemplary player ranking

### DETAILED DESCRIPTION

As noted above, workplace incentive programs generally are either individualized, or are team-based without individual metrics. As a result, current workplace incentive programs may encourage potentially detrimental individual competition in addition to productive competition, and/or may not adequately incentivize contribution by each and every individual toward a team goal. A workplace fantasy league may provide individual incentive in a team-based setting, thus encouraging productive competition and teamwork. Accordingly, a workplace fantasy league may improve upon known workplace incentive programs.

Fantasy leagues are generally known, for example, for various professional sports leagues. Such leagues generally involve each team in the fantasy league selecting individuals, groups of individuals, or teams from, for example, a single professional sports league. The performances of the individuals, groups of individuals, and teams from the professional league are recorded (for example, on a game-by-game basis) and may be converted into points for the purposes of the fantasy league. Each team in the fantasy league thus acquires points according to the performance of the individuals, groups of individuals, and teams from the professional league that are assigned to that fantasy team.

A workplace fantasy league may operate similarly to a sports fantasy league. However, instead of fantasy teams being assigned individuals from professional or other teams, the teams in a workplace fantasy league may be made up of the actual employees in that workplace. Accordingly, team success may act as an incentive to encourage positive performance from employees, both as individuals and as part of a team.

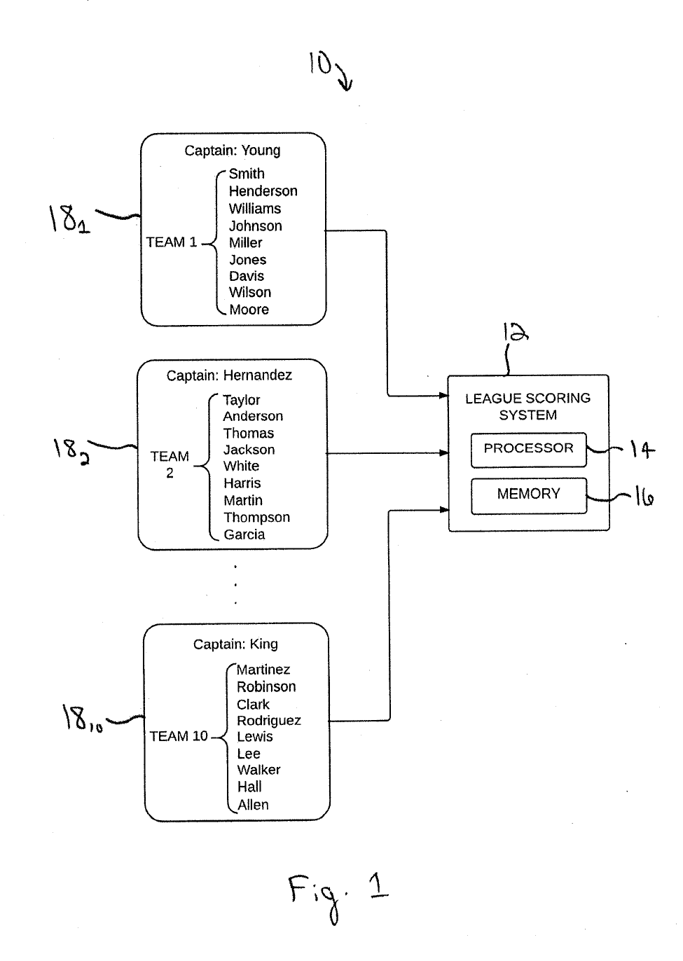

Referring to the figures, wherein like reference numerals refer to the same or similar features in the various views, FIG. 1 is a block diagram view of a system 10 for implementing a workplace fantasy league. The system 10 may include a league scoring computer system 12 (which may be referred to simply as the scoring system 12) including a processor 14 and a computer-readable memory 16. The memory 16 may include instructions that, when executed by the processor 14, cause the scoring system 12 to perform one or more of the tasks and methods described herein including, but not limited to, scoring and reporting the results of matches in a workplace fantasy league.

The memory 16 may be any type of volatile or non-volatile computer-readable memory. For example, the memory may comprise a hard disk drive (HDD), random-access memory (RAM), read-only memory (ROM), electrically-erasable programmable read-only memory (EEPROM), FLASH memory, compact disk (CD), digital video disk (DVD), and/or another type of electronic storage medium. The processor 14 may include any type of processor.

In addition to or as an alternative to a processor 14 and memory 16, the scoring system 12 may comprise another type of processing device. For example, the scoring system 12 may include a field-programmable gate array (FPGA), application-specific integrated circuit (ASIC), programmable logic device (PLD), and/or another type of processing device.

The scoring system 12 may be implemented as a unitary system, in an embodiment (e.g., a personal computer or single server). Alternatively, the scoring system 12 may include multiple devices, which devices may be located in substantially the same location (e.g., on a single local area network (LAN)), or which may be remote from each other. The scoring system 12 may be implemented as a cloud-based service, in an embodiment (e.g., may be provided on a software-as-a-service basis). In a further example, the scoring system 12 may be implemented on a database or other computing platform and may be accessed remotely through a hardware-based or software-based terminal.

The scoring system 12 may be configured to determine scores for a plurality of fantasy league teams 18 on a periodic basis, in an embodiment. For example, a workplace fantasy league may include ten (10) teams 18₁, 18₂, . . . , 18₁₀, in an embodiment, which teams may be referred to individually (and generically) as a team 18, or which may be referred to collectively as the teams 18. Each team may include nine (9) individuals, or “players”, and a “captain”, for example only. Of course, in different embodiments, a league may include any number of teams 18, and a team 18 may include any number of players, and a team may include any number of captains or no captain.

An exemplary embodiment of a workplace fantasy league will be described herein with reference to the transportation industry, and more specifically with reference to the trucking industry. Thus, a game for a plurality of employees involved in the transportation of goods or passengers will be described. It should be understood that such description is for example purposes only, and is not limiting. Instead, except as otherwise stated in the claims, the instant disclosure may be applied to any industry, and to any workplace. Furthermore, for ease of reference, a workplace fantasy league will be described with reference to an embodiment having ten (10) teams 18, each having nine (9) players and a captain. Again, this is merely exemplary, and is not limiting except as explicitly set forth in the claims. Still further, a workplace fantasy league according to the present disclosure is not limited to a set of employees of a single organization. Instead, a workplace fantasy league may be implemented by any organization or group of organizations and may involve any individuals associated with the organization or organizations, in an embodiment.

In an embodiment, the captain of a team 18 may be an individual who has authority over or provides assistance to other employees in the workplace, and the players on the team 18 may be selected from those other employees. For example, in an embodiment, team captains may be dispatchers, and the players may be drivers. In other embodiments, team captains may be selected from the same set or level of employees as the players, and/or the players may include individuals with different roles.

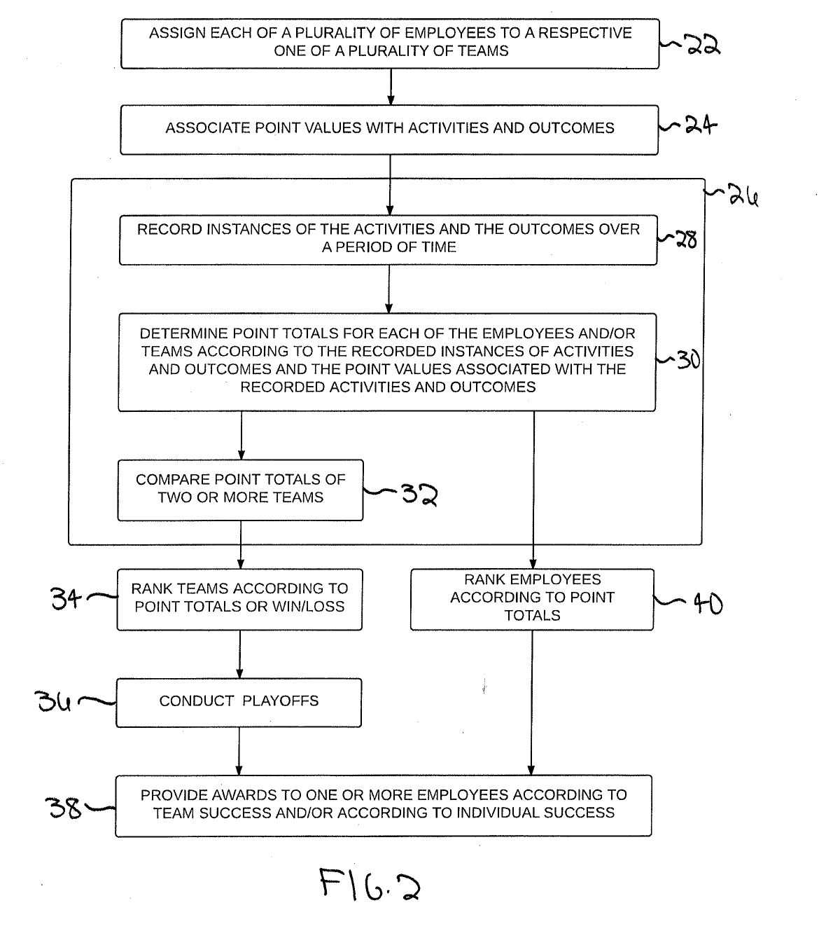

FIG. 2 is a flow chart illustrating a method 20 of operating a workplace fantasy league. Referring to FIGS. 1 and 2, one or more steps of the method 20 may be performed by the scoring system 12 (e.g., stored in the memory 16 as instructions configured to be executed by the processor 14).

The method 20 may begin with a step 22 of assigning each of a plurality of employees to a respective one of a plurality of teams. Players may be assigned to teams 18 in a draft, in an embodiment. The draft may proceed as generally known for fantasy drafts. For example, in an embodiment, players may be assigned to teams 18 according to what is known as a “snake”-style draft. In such a draft, each team 18 is assigned a position in the draft order, from first to last (which, in the illustrated embodiment, would be tenth). The team 18 with first draft position may select a player from the pool of available players, and the selected player is assigned to that team 18. When a player is selected, that player is removed from the pool of available players. The team 18 with second draft position may then select a player from the pool of available players, and the selected player is assigned to that team 18 and removed from the pool of available players. The team 18 with third draft position may then select a player, and so on through the team with tenth draft position. A single set of selections—that is, one selection by each team—may be known as a “round” of the draft. The selection by the team 18 having tenth draft position may complete the first round.

The second round may begin with the team 18 with tenth (i.e., final) draft position selecting first, followed by the team 18 in ninth position, then the team 18 in eighth position, and so on through the team 18 in first position. The selection by the team 18 having first draft position may complete the second round.

The third and subsequent odd-numbered rounds may proceed in the same manner as the first round, and the fourth and subsequent even-numbered rounds may proceed in the same manner as the second round. The draft may proceed until each team has reached a desired number of players, and/or until the pool of available players is empty.

Draft position may be determined randomly, in an embodiment. For example, the scoring system may automatically assign draft positions to the teams in the league. In another example, the captains of the teams in the league may draw lots to determine draft position. In yet another embodiment, draft position may be determined non-randomly, such as through a bidding process or according to results from a previous season of the fantasy league, for example only.

The draft may be conducted by or through the scoring system 12, in an embodiment. For example, the scoring system 12 may provide an input through which teams 18 may input their selections during the draft, and may automatically assign those selections to the teams 18 and remove selected players from the pool of available individuals. Alternatively, the scoring system 12 may receive a list of selections after the draft is completed, and may assign selected players to their teams 18 according to those selections.

Following the draft, there may be individuals that are not on any team. That is, there may be some individuals from the pool of “draftable” individuals that are not assigned to any team in the draft. For example, the pool of individuals may be larger than the total number of players collectively assigned to the teams 18. Such individuals may be available to be added to teams throughout the season. Accordingly, an individual may be assigned to and/or removed from a team during the season, in an embodiment.

The method 20 may further include a step 24 of associating point values with activities that may be undertaken by the employees in the league and with outcomes that may be affected by the employees. As in other fantasy leagues, a workplace fantasy team 18 may accumulate points according to the performance of the players on the team 18. Unlike known fantasy leagues, however, the players in a workplace fantasy league according to the present disclosure may have a stake in the outcome of the fantasy league through league awards and friendly competition within the workplace. As a result, the workplace fantasy league may be an effective tool to encourage performance of players on a team and to encourage cooperation and teamwork among players on a team.

A workplace fantasy league may provide awards and other incentives by ranking the performances of the teams in the league. In an embodiment, team performances may be ranked in a series of matchups comprising a “season.” A season may include, for example, a series of matchups between individual teams, each matchup encompassing a predetermined period of time. For example, each matchup may be a predetermined number of days, or a week, in an embodiment. A workplace fantasy league season will be described with reference to an embodiment in which each matchup encompasses a week, but this is for ease of description only. A workplace fantasy league is not limited to season based on weekly matchups or on any other season or ranking structure except as explicitly recited in the claims.

Each week of a fantasy workplace league, each team may have a matchup with another team in the league. For example, in a ten-team league, in an exemplary week, Team 1 may have a matchup with Team 10, Team 2 with Team 9, Team 3 with Team 8, Team 4 with Team 7, and Team 5 with Team 6. Each team's performance may be quantified into a score for the week (e.g., through points accumulated according to activities performed and outcomes achieved by members of each team), and the scores of the two teams in a matchup may be compared at the end of the week. The team with the higher score may be declared the winner of the matchup.

A matchup 26 may include a number of steps 28, 30, 32 in the method 20. For example, a first step 28 of a matchup 26 may include recording instances of the activities and outcomes that are associated with point values over a predetermined period of time. As noted above, the period of time may be a number of days, a week, or some other period of time. Instances of activities and outcomes may be recorded automatically, in an embodiment. For example, activities and outcomes may be reported in business-driven systems (e.g., accounting systems, inventory systems, scheduling systems, and the like), and may be retrieved or received by the scoring system 12. Additionally or alternatively, the scoring system 12 may be associated with one or more input devices to receive manual input of activities and outcomes that may be associated with points. The scoring system 12 may thus be configured to receive and record activities and outcomes.

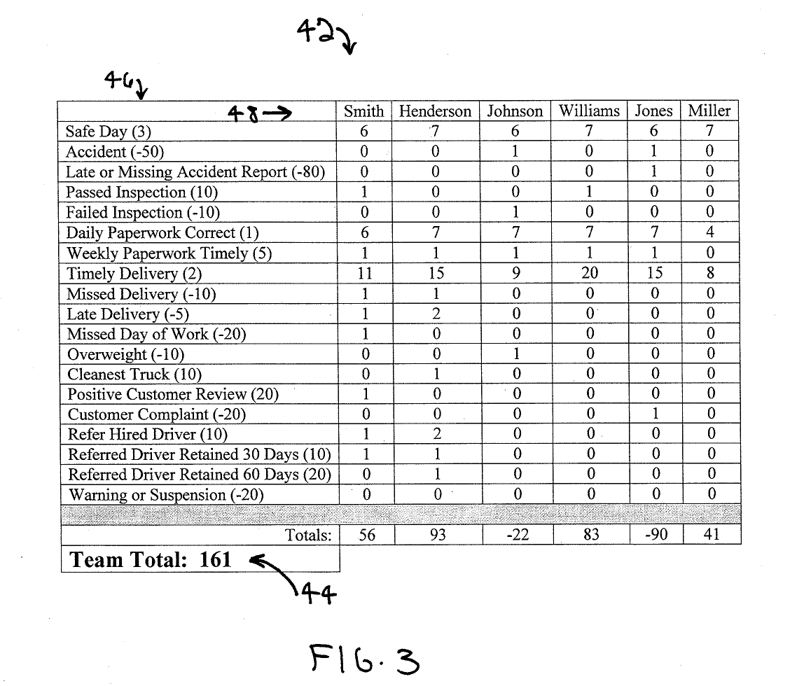

A further step 30 in a matchup 26 may include determining point totals for each of the teams in the league according to the recorded instances of activities and outcomes and according to the point values associated with the recorded activities and outcomes. FIG. 3 is a table 42 illustrating an exemplary weekly score 44 for a single team 18₁ in a workplace fantasy league. The table 42 reflects the activities and outcomes that are assigned points in the league, and the instances of those activities and outcomes for each player on the team for the week.

For a particular week, a team may be required to “play” only a subset of the players on the team. That is, only the points accumulated by those players count towards that week's score, and points accumulated by other players (i.e., those who are not “played”) would not count towards the team's score. Accordingly, FIG. 3 illustrates the scores of the six players selected to play for Team 1 in the exemplary week.

With continued reference to FIG. 3, in an embodiment in which the workplace fantasy league is for a trucking workplace, activities and outcomes to which points are assigned, and exemplary points assigned to those activities and outcomes, are shown in the first column 46 of the table 42 and may include: Safe Day (3 points); Accident (−50); Late or Missing Accident Report (−80); Passed Inspection (10); Failed Inspection (−10); Daily Paperwork Correct (1); Weekly Paperwork Timely (5); Timely Delivery (2); Missed Delivery (−10); Late Delivery (−5); Missed Day of Work (−20); Overweight (−10); Cleanest Truck (10); Positive Customer Review (20); Customer Complaint (−20); Refer Hired Driver (10); Referred Driver Retained 30 Days (10); Referred Driver Retained 60 Days (20); Warning or Suspension (−20). Activities and outcomes are shown in the first column of FIG. 3, which each row corresponding to an activity or outcome.

The activities and outcomes for which points are awarded may be tailored to the business needs of the workplace—i.e., to the behavior sought to be incentivized or dis-incentivized. For example, in an embodiment, if a business wishes to emphasize safety for a particular week, month, etc., safety-related categories may be associated with heightened point totals for that week, month, etc. Similarly, if a business wishes to recover or account for missing inventory, supplies, etc., points may be awarded for a season or limited time for the recovery of such inventory, supplies, etc. Accordingly, in an embodiment, the activities and outcomes for which points are awarded may change over the course of a season to reflect different business goals of the underlying business, or for some other reason. Similarly, different activities and outcomes may be scored differently for different types of employees. For example, point totals may be heightened for new employees for activities and outcomes that are particularly important or more difficult for new employees. Furthermore, different activities and outcomes may be scored for different employees based on the different roles of those employees, and the activities required for or implicated by those roles.

Referring to FIGS. 1 and 3, the players listed in the first row 48 of the table correspond to the players assigned to Team 1, with each column corresponding to an individual player's activities and outcomes for the week. Each player's activities and outcomes for the week may be recorded (e.g., as shown in the table). A point total may be determined for each player and/or for the team according to the recorded activities and outcomes and the points assigned to those recorded activities and outcomes. As shown in the exemplary table of FIG. 2, for the week shown, Team 1 has acquired one hundred and sixty-one (161) points from the activities and outcomes of its players.

Although a compiled score for a week is shown in FIG. 3, score tables (i.e., tables of results and outcomes and the points associated with those results and outcomes) may be generated and displayed for a user for any period of time, in an embodiment. Furthermore, although the table of FIG. 3 illustrates only the scores of those players selected to “play” for a given week, even players whose scores do not count for a given time period or matchup may be displayed in a score table. Accordingly, in an embodiment, a score table may further include an indication of which players are selected to “play” for a given matchup or period of time.

Referring again to FIG. 2, a matchup 26 may further include a step 32 of comparing point totals of two or more teams to determine a matchup winner. In the week for which the results of Team 1 are illustrated in the table of FIG. 3, Team 1 may have a matchup with Team 10, for example. The point total for Team 10 may be determined in a similar fashion to the point total for Team 1, and the point total of Team 1 may be compared to the point total of Team 10. The team with the higher point total may be declared the winner of the matchup. If the two teams have the same point total, the matchup may be declared a tie, or a tie-breaker may be implemented. A tie breaker may be, for example, a score in a given category, some other performance-related comparison, or may be random, such as a coin flip.

For each week, a winner (or tie) may be determined for each of the inter-team matchups. Multiple weeks may be included in a “season”, in an embodiment. Thus, the steps included in a matchup 26 may be repeated numerous times over the course of a season, in an embodiment. The number of weeks (that is, matchups) included in a season may be predetermined, and may be selected according to a desired period of time over which it is desired to motivate the individuals involved in the league (e.g., the players and captains).

The method may further include a step 34 of ranking teams according to point totals (i.e., rotisserie-style standings) and/or win/loss record. Team rankings may be used to determine playoff seeding and playoff matchups, for example, or may otherwise be used as the basis for awarding prizes.

At the end of a season, a step 38 of providing an award to one or more employees of the winning team or teams may be performed. This award step 38 presents a unique advantage over known fantasy games, in that awards are provided to those individuals whose activities and outcomes are scored in determining the winners of the league. Awards may be provided to some or all players and captains (e.g., on an individual basis, or to the team collectively) of fantasy league teams that won the most matchups during the season to finish highest in the league standings. For example, in an embodiment, the highest three teams in the standings may be provided awards.

In addition, or as an alternative, the award step 38 may include providing awards to one or more employees according to individual performance or success. For example, an embodiment of the method 20 may include a step 40 that includes ranking each player in the league according to point totals accumulated during the season. One or more players having the highest rank(s) may be given awards, in an embodiment. Individual success (i.e., rankings) may be determined according to performance for each employee for the entire season, in an embodiment, including employees not on a team for some or all of the season, including employees on a team that don't “play” every week, etc. As a result, each employee may be motivated both by team-based and individual-based awards, in an embodiment. Individual awards may be provided based on season performance, based on playoff performance, or based on both, in embodiments.

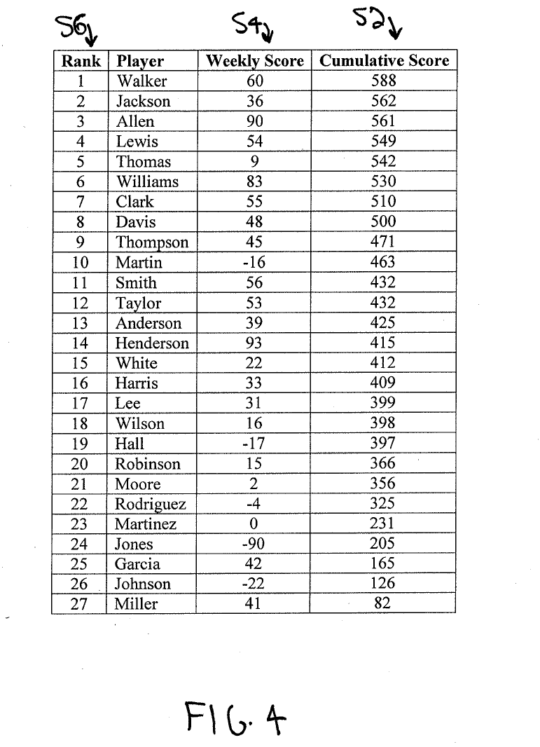

FIG. 4 is a table 50 illustrating an exemplary player ranking according to cumulative scores for the players illustrated in FIG. 1 following the week illustrated in FIG. 3. Referring to FIG. 4, a player's cumulative score (shown in the fourth column 52 of the table 50) may be a compilation of all of the points accumulated by that player through a given point in the season. A cumulative score may be displayed next to a weekly score (shown in the third column 54), in an embodiment, as in FIG. 3. Players may be ranked according to a cumulative score (as in the table 50 of FIG. 4), according to a weekly score, and/or according to points accumulated in some other period of time or in some subset of scored activities and outcomes. All players in a league may be ranked against each other, or a subset of the players in a league may be ranked against each other. In the table 50 of FIG. 4, player ranks according to cumulative points are shown in the first column 56 of the table 50.

At the end of the season, the method 20 may include a step 36 of conducting playoffs to determine one or more winners, in an embodiment. Playoffs may include additional matchups between teams. In an embodiment, only a certain number of teams from the league may be included in the playoffs. For example, in the exemplary ten-team league, four teams may be included in the playoffs. The teams included in the playoffs may be the teams that are highest in the standings, in an embodiment. Playoff matchups may be determined by “seeding” teams according to season results, in an embodiment. Thus, the team highest in the standings may play the team lowest in the standings that is in the playoffs, the second-highest team in the standings may play the second-lowest team in the playoffs, and so on. Each playoff matchup may be of the same duration as matchups during the season (e.g., one week, for example only), in an embodiment. The winner of a playoff matchup may advance to another playoff matchup, and the loser may be eliminated, in an embodiment. The final remaining team may be the winner of the playoff.

Referring to FIGS. 1-3, the league scoring system 12 may provide a number of features and functionality in addition to or instead of those features and functions illustrated in and described with respect to FIGS. 1-3. For example, the league scoring system may be configured to provide a user with the ability to, e.g., check aspects of the format of a league (e.g., divisions, schedules, etc.), check rosters of one or more teams, edit rosters of one or more teams (e.g., to set which players are “playing” for a given match or time period, to add players to a team, remove players from a team, etc.), check matchup results and season standings, add and edit players, and so on. In an embodiment, the league scoring system may be configured to provide features and functions through a graphical and/or text-based user interface.

Numerous changes may be made to the format of a workplace fantasy league without departing from the spirit and scope of the present disclosure. Draft format, lengths of matchups, the length of the season, the number of teams, the number of players per team, the activities and outcomes that are awarded points, the number of points for any particular activity or outcome, and additional aspects may be customized according to the needs of a particular league. For example, league standings may be determined according to what is known in fantasy league scoring as a rotisserie-style format, in which individual matchups are replaced by a season-long ranking of each team in each scored activity and outcome.

Although a number of embodiments have been described above with a certain degree of particularity, those skilled in the art could make numerous alterations to the disclosed embodiments without departing from the sprit or scope of this disclosure. For example, all joinder referenced (e.g., attached, coupled, connected, and the like) are to be construed broadly and may include intermediate members between a connection of elements and relative movement between elements. As such, joined references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Further, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

What is claimed is:

1. A non-transitory computer-readable medium containing instructions that, when executed, cause a computer to execute a method for operating a game for a plurality of employees involved in the transportation of goods or passengers, the method comprising:
assigning each of the plurality of employees to a respective one of a plurality of teams, such that each of the plurality of teams comprises two or more of the plurality of employees;
associating respective point values with at least one of: (a) each of a plurality of activities that may be undertaken by one or more of the plurality of employees or one or more of the plurality of teams, and (b) each of a plurality of outcomes that may be affected by one or more of the plurality of employees or one or more of the plurality of teams;
recording instances of the activities and the outcomes over a predetermined period of time; and
determining point totals for each of the teams for the predetermined period of time according to the recorded instances of activities and outcomes and the respective point values associated with the recorded activities and outcomes.

2. The computer-readable medium of claim 1, wherein at least some of the activities and the outcomes are related to employee safety.

3. The computer-readable medium of claim 2, wherein the activities and outcomes comprise one or more of a period of time without an accident, a time between an accident and when the accident is reported, a passed inspection, and a failed inspection.

4. The computer-readable medium of claim 1, wherein at least some of the activities and outcomes are related to employee productivity.

5. The computer-readable medium of claim 4, wherein the activities and outcomes comprise one or more of a period of time with required documentation timely submitted by an employee, an instance of properly completed documentation by an employee, a completed delivery, a missed delivery, an instance of tardiness, an instance of missing a day of work, referral of an employment candidate who is hired as an employee, and referral of an employment candidate who is hired as an employee and retained as an employee for a predetermined period of time.

6. The computer-readable medium of claim 1, wherein determining point totals comprises adding up point totals for a respective subset of the employees associated with each respective team while ignoring point totals for employees not in a respective subset.

7. The computer readable-medium of claim 1, wherein the method further comprises comparing determined point totals of at least two teams to each other to determine a winner for the predetermined period of time.

8. The computer-readable medium of claim 7, wherein the method further comprises repeating said recording and said determining for a plurality of successive predetermined periods of time, wherein each of the plurality of teams acquires a win, loss, or tie for each of the successive predetermined periods of time, and ranking the teams according to win/loss record.

9. The computer-readable medium of claim 1, wherein the predetermined period of time is a first period of time and the activities and outcomes are first activities and first outcomes, wherein the method further comprises:
associating respective point values with at least one of: (a) each of a second plurality of activities that may be undertaken by one or more of the plurality of employees or one or more of the plurality of teams, and (b) each of a second plurality of outcomes that may be affected by one or more of the plurality of employees or one or more of the plurality of teams;
recording instances of the second activities and the second outcomes over a second predetermined period of time; and
determining point totals for each of the teams for the second predetermined period of time according to the recorded instances of activities and outcomes and the respective point values associated with the recorded activities and outcomes;
wherein at least some of the second activities and outcomes are different from the first activities and outcomes.

10. The computer-readable medium of claim 1, wherein the activities and outcomes are first activities and first outcomes, wherein the method comprises:
associating respective point values comprises associating respective point values with at least one of: (a) each of the first plurality of activities that may be undertaken by a first subset of the plurality of employees and each of a second plurality of activities that may be undertaken by a second subset of the plurality of employees, wherein the first plurality of activities is different from the second plurality of activities and the first subset of employees is different from the second subset of employees; and (b) each of the first plurality of outcomes that may be affected by the first subset of the plurality of employees and each of a second plurality of outcomes that may be affected by the second subset of the plurality of employees, wherein the first plurality of outcomes is different from the second plurality of outcomes;
recording instances of the first activities, the second activities, the first outcomes, and the second outcomes over the predetermined period of time; and
determining point totals for each of the teams for the predetermined period of time according to the recorded instances of first and second activities and outcomes and the respective point values associated with the recorded first and second activities and outcomes.

11. A method for operating a game for a plurality of employees involved in the transportation of goods or passengers, the method comprising:
assigning, by a processor, each of the plurality of employees to a respective one of a plurality of teams, such that each of the plurality of teams comprises two or more of the plurality of employees;
associating, by a processor, respective point values with at least one of: (a) each of a plurality of activities that may be undertaken by one or more of the plurality of employees or one or more of the plurality of teams, and (b) each of a plurality of outcomes that may be affected by one or more of the plurality of employees or one or more of the plurality of teams;
recording, by a processor, instances of the activities and the outcomes over a predetermined period of time;
determining, by a processor, point totals for each of the teams for the predetermined period of time according to the recorded instances of activities and outcomes and the respective point values associated with the recorded activities and outcomes; and
providing an award to one or more of the plurality of employees according to the determined point totals.

12. The method of claim 11, wherein at least some of the activities and the outcomes are related to employee safety.

13. The method of claim 12, wherein the activities and outcomes comprise one or more of a period of time without an accident, a time between an accident and when the accident is reported, a passed inspection, and a failed inspection.

14. The method of claim 11, wherein at least some of the activities and outcomes are related to employee productivity.

15. The method of claim 14, wherein the activities and outcomes comprise one or more of a period of time with required documentation timely submitted by an employee, an instance of properly completed documentation by an employee, a completed delivery, a missed delivery, an instance of tardiness, an instance of missing a day of work, referral of an employment candidate who is hired as an employee, and referral of an employment candidate who is hired as an employee and retained as an employee for a predetermined period of time.

16. The method of claim 11, wherein determining point totals comprises adding up point totals for a respective subset of the employees associated with each respective team while ignoring point totals for employees not in a respective subset.

17. The method of claim 11, wherein the method further comprises comparing determined point totals of at least two teams to each other to determine a winner for the predetermined period of time.

18. The method of claim 17, wherein the method further comprises repeating said recording and said determining for a plurality of successive predetermined periods of time, wherein each of the plurality of teams acquires a win, loss, or tie for each of the successive predetermined periods of time, and ranking the teams according to win/loss record.

19. The method of claim 11, wherein the predetermined period of time is a first period of time and the activities and outcomes are first activities and first outcomes, wherein the method further comprises:
associating respective point values with at least one of: (a) each of a second plurality of activities that may be undertaken by one or more of the plurality of employees or one or more of the plurality of teams, and (b) each of a second plurality of outcomes that may be affected by one or more of the plurality of employees or one or more of the plurality of teams;
recording instances of the second activities and the second outcomes over a second predetermined period of time; and
determining point totals for each of the teams for the second predetermined period of time according to the recorded instances of activities and outcomes and the respective point values associated with the recorded activities and outcomes;
wherein at least some of the second activities and outcomes are different from the first activities and outcomes.

20. The method of claim 11, wherein the activities and outcomes are first activities and first outcomes, wherein the method comprises:
associating respective point values comprises associating respective point values with at least one of: (a) each of the first plurality of activities that may be undertaken by a first subset of the plurality of employees and each of a second plurality of activities that may be undertaken by a second subset of the plurality of employees, wherein the first plurality of activities is different from the second plurality of activities and the first subset of employees is different from the second subset of employees; and (b) each of the first plurality of outcomes that may be affected by the first subset of the plurality of employees and each of a second plurality of outcomes that may be affected by the second subset of the plurality of employees, wherein the first plurality of outcomes is different from the second plurality of outcomes;
recording instances of the first activities, the second activities, the first outcomes, and the second outcomes over the predetermined period of time; and
determining point totals for each of the teams for the predetermined period of time according to the recorded instances of first and second activities and outcomes and the respective point values associated with the recorded first and second activities and outcomes.
